(19) United States
(12) Patent Application Publication
(10) Pub. No.: US 2011/0053418 A1
(43) Pub. Date: Mar. 3, 2011

(54) MODULAR JACK WITH TWO-PIECE HOUSING AND INSERT

(75) Inventors: Yan Margulis, Lisle, IL (US); Johnny Chen, Lisle, IL (US); Peter Lassen, Lisle, IL (US)

(73) Assignee: MOLEX INCORPORATED, Lisle, IL (US)

(21) Appl. No.: 12/446,131

(22) PCT Filed: Nov. 13, 2006
(86) PCT No.: PCT/US06/43982

§ 371 Date: Nov. 8, 2010

Related U.S. Application Data
(60) Provisional application No. 60/865,278, filed on Nov. 10, 2006.

(51) Int. Cl. H01R 13/7193; H01R 13/719; H01F 27/02; H01R 43/20

(52) U.S. Cl. 439/620.07; 439/620.21; 336/96; 29/876

(57) ABSTRACT

A modular jack system where the jack includes two halves having cavities that are configured to mate with one another other. The filtering components are placed inside the cavities of either one or both halves of the housing and potted prior to assembly. A shock absorbing insert is then placed between the two halves to protect any filtering components or assemblies located within the magjack housing. The halves of the housing are then brought together to form the enclosure or housing.

### BACKGROUND

1. Field of the Invention

The present invention relates generally to modular telecommunications jacks and, more particularly, to a modular jack having a two-piece housing and a shock absorbing insert.

2. Description of Related Art

Modular jack (“modjack”) receptacle connectors mounted to printed circuit boards (PC boards) are well known in the telecommunications industry. These connectors are typically used for electrical connection between two electrical communication devices. With ever-increasing operating frequencies of data and communication systems and an increased density of information to be transmitted, the electrical characteristics of such connectors are of increasing importance. In particular, it has to be ensured that these modjack type connectors do not have deleterious effects on the signals to be transmitted and that no additional interference is introduced. Based on these requirements, various proposals have been made in order to minimize negative influences, especially of modjack connectors, used with communication or transmission links.

When used as Ethernet connectors, modular jacks generally receive an input signal from one electrical device and then communicate a cleaned up corresponding output signal to a second device coupled thereto. Magnetic circuitry is used in the transfer of the input signal of one device to the output signal of the second device and also cleans the input signal during transfer from the first device to the second. Currently, modjacks are made using a single channel ferrite choke. Usually these chokes are toroidal magnetic ferrite common mode chokes for use in various filtered connectors. The chokes are used to reduce the amount of unwanted common mode signal in differential signaling applications.

For the elimination of in-phase interference signal noise components, U.S. Pat. No. 5,015,204 teaches use of a common-mode choke arranged in a connector housing around which the contact leads of a RJ-45 modjack connector are integrally wound. In this design, the common-mode choke takes up a substantial portion of the connector housing, although only two signal-conducting leads are used. Furthermore, the respective leads need a certain rigidity to provide resilient forces to continuously facilitate a secure contact with the associated modular plug connector. Unfortunately, this makes for difficult manufacturing conditions, especially when the rigid wires have to be wound around the conductive core of the choke coil and the entire assembly placed within the modjack housing.

More particularly, difficulty in manufacturing arises from the fact that currently available modjacks are manufactured such that they are formed using a single frame configuration. That is, the modjack includes a hollow box-shaped housing that is formed as a single piece component. Magnets, choke coils and other filtering components are then placed within the frame through the relatively narrow opening. These components are then potted using silica gel, which once again must be applied through the relatively small opening in the modjack housing.

Therefore, it can be seen that inserting and potting of the components is difficult because of the relative inaccessibility of the interior of the single piece modjack housing. Furthermore, the performance of the choke in known modjack designs is significantly reduced if an unbalanced DC current is applied to the circuit. This may occur in Power over Ethernet type of applications because of the saturation of the ferrite core.

### DESCRIPTION OF THE DRAWINGS

Various other objects, features and attendant advantages of the present invention will become more fully appreciated as the same becomes better understood when considered in conjunction with the accompanying drawings, in which like reference characters designate the same or similar parts throughout the several views in which:

FIG. 1 is a front isometric view of a modjack in accordance with an embodiment of the invention;

FIG. 2 is a partially exploded view of the modjack of FIG. 1 with the outer shielding removed;

FIG. 3 is a rear isometric view of the modjack of FIG. 2;

FIG. 4 is partially exploded view of the modjack of FIG. 3 with the internal modules removed;

FIG. 5 is an isometric view of a single internal module;

FIG. 6 is an exploded view of the internal module of FIG. 5;

FIG. 7 is an exploded view of a component housing of the internal module of FIG. 6 showing noise reduction components;

FIG. 8 is a wiring diagram for a transformer wire winding assembly;

FIG. 9 is a wiring diagram for a transformer and choke wire winding subassembly;

FIG. 10 is a wiring diagram for a PoE choke wire winding subassembly;

FIG. 11 is a partially assembled isometric view of the housing of the internal module with the noise reduction components inserted into the housing;

FIG. 12 is a partially assembled isometric view of the housing of the internal module with a shock absorbing insert placed into the housing; and

FIG. 13 is a cross section of a fully assembled component housing of FIG. 6.

### DETAILED DESCRIPTION

In order to provide a modular jack with magnetic filtering (magjack) that avoids the problems of the prior art and also which is able to increase performance and ease of manufacturing, there is provided a modular jack system where the jack includes two component housing halves that are configured to mate with one another other. The filtering components or magnetics, which may include a multichannel choke, are placed inside either one or both halves of the housing and potted prior to assembly. A shock-absorbing insert is also placed between the two halves to protect any filtering components or assemblies located within the component housing. The halves of the housing are then brought together to form the assembled component enclosure or housing.

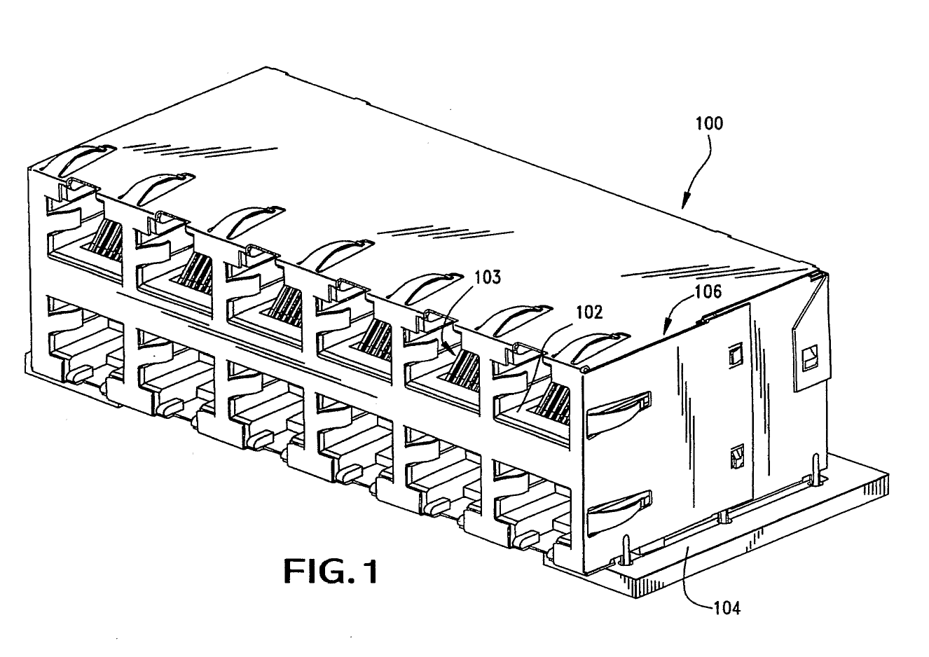

FIG. 1 illustrates the front side of an exemplary embodiment of the present invention in its fully assembled form. As shown, the magjack 100 is a multiple input, stacked jack for receiving multiple Ethernet or RJ-45 type of plugs (not shown). The magjack 100 includes a magjack housing 102 made of an insulating material such as 30% glass filled PBT or other similar material and includes front side openings 103 that are configured to receive Ethernet or RJ-45 type jacks (not shown). The magjack 100 is mounted on circuit board 104. Metal or other conductive shielding 106 is used to surround the magjack housing 102 for RF and EMI shielding purposes as well as for providing a ground. It should be noted that similar configurations are possible in situations where only a single unit magjack is desired.

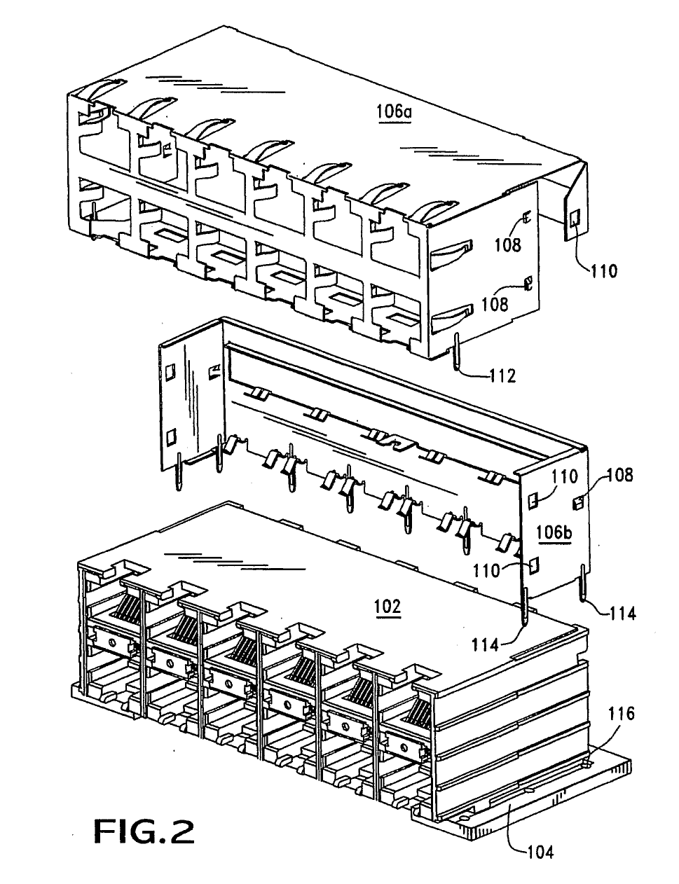

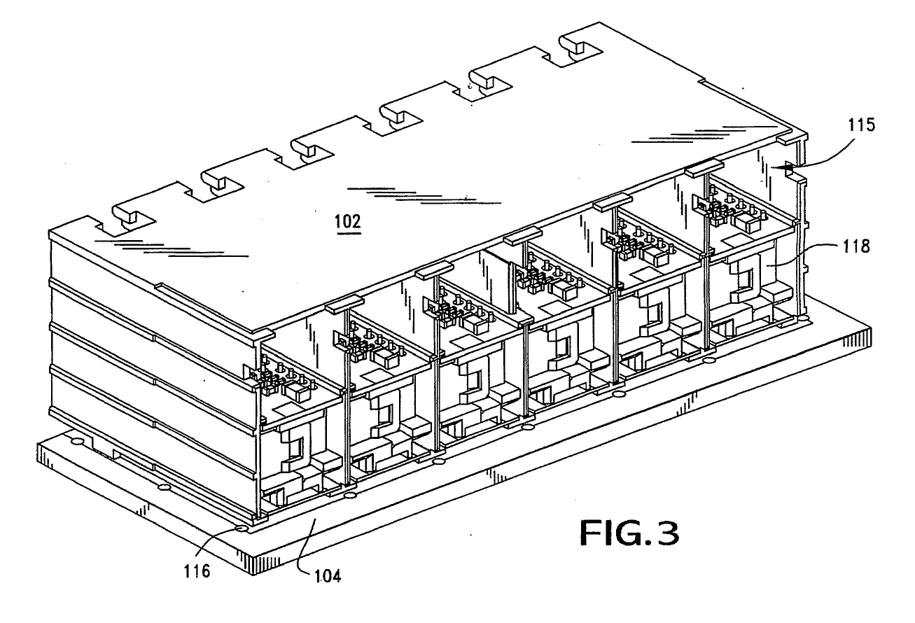

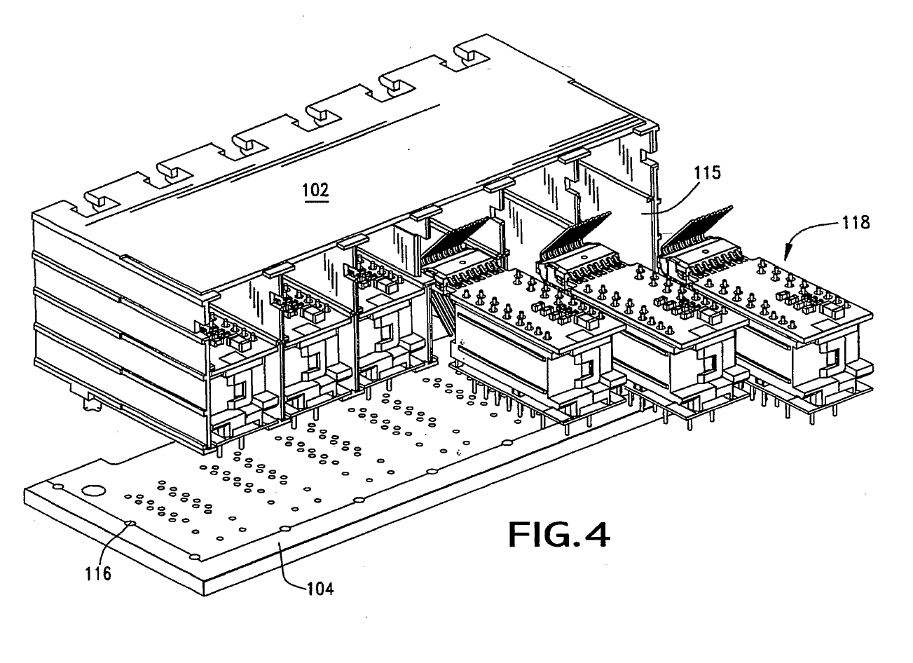

The shielding 106, as shown in FIG. 2, is configured such that it may be installed on the magjack 100 subsequent to the magjack 100 being assembled and mounted on the circuit board 104. The shielding 106 includes a front shield 106a and a back shield 106b. These joinable shields are formed with interlocking tabs 108, 110 for engaging and securing each other when the shielding 106 assembly is placed into position around the magjack 100 and onto the circuit board 104. Each of the shields 106a, 106b includes guide posts 112, 114 that are placed into through-holes 116 on the circuit board 104. As shown in FIG. 3, the back portion of the exemplary magjack housing 102 includes relatively large openings 115 that are sized and shaped to receive internal subassembly modules 118 (FIG. 4). These modules 118 provide the physical contacts for engaging Ethernet plugs and also provide the electrical functionality of the jacks, such as Power Over Ethernet (POE). A particular advantage of the present modular system is that the entire magjack 100 does not need to be populated with the same internal subassembly modules or more than a single external module at all. This helps keep manufacturing costs low and enables the manufacturer to customize the magjack as need by the customer.

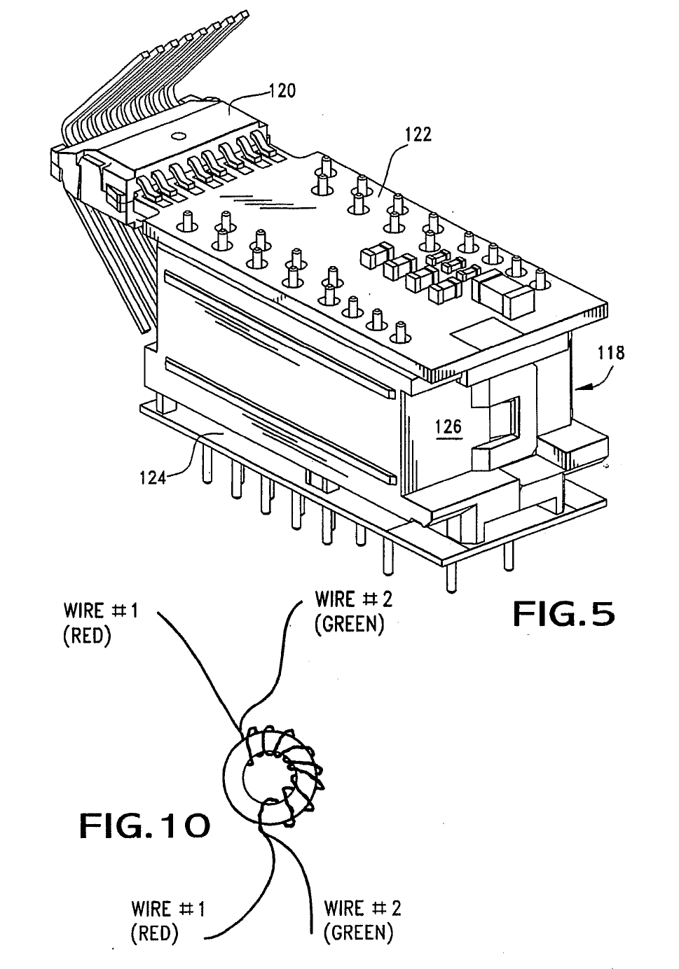

FIG. 5 shows a detailed view of the exterior of the subassembly module 118. The module 118 includes a contact module 120 that is electrically connected to a top printed circuit board (PCB) 122. The top PCB 122 is mounted to a component housing 126, which includes magnetic circuits and filtering components. The component housing 126 is then mounted on a bottom PCB 124.

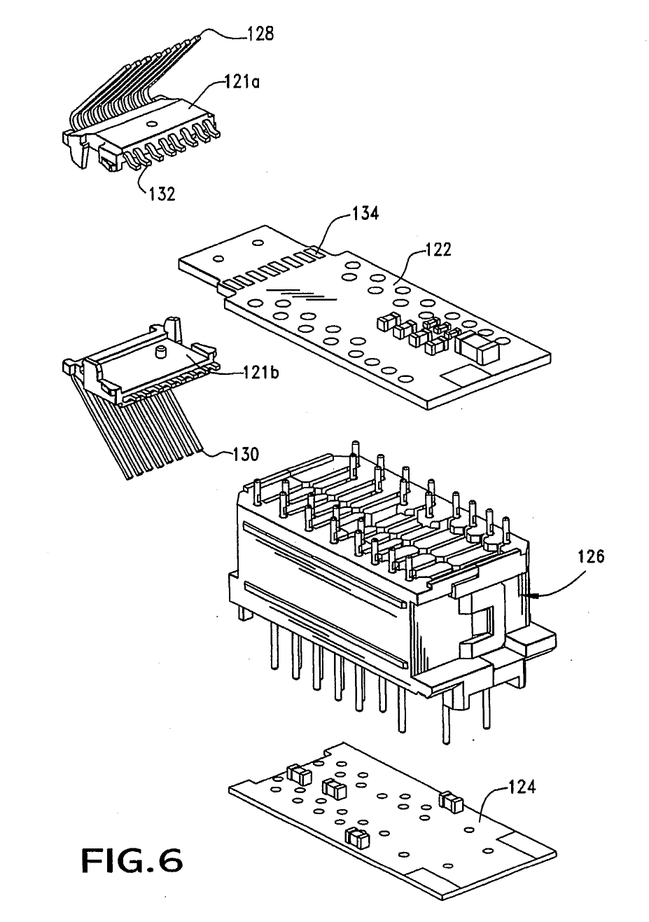

As shown more clearly in FIG. 6, the contact module 120 includes a top contact assembly 121a and a bottom contact assembly 121b for providing stacked jack, or dual jack, functionality. The top contact assembly 121a provides physical and electrical interfaces, including upwardly extending contact terminals 128, for connecting to an Ethernet plug. The bottom contact assembly 121b, which may be omitted in a single port magjack configuration, is physically connected to the top contact assembly 121a and includes downwardly extending contact terminals 130. The contact terminals are manufactured from any material that provides electrical conductivity and is at least somewhat malleable so as to be able to be formed into a particular shape. The contact module 120 is functionally connected to the top PCB 122 through leads 132, which are soldered, or electrically connected by some other means, onto the top PCB pads 134.

The top and bottom PCBs 122, 124 include the resistors, capacitors and any other components associated with the chokes and transformers located inside the component housing 126, which together comprise the filtering circuitry of the magjack.

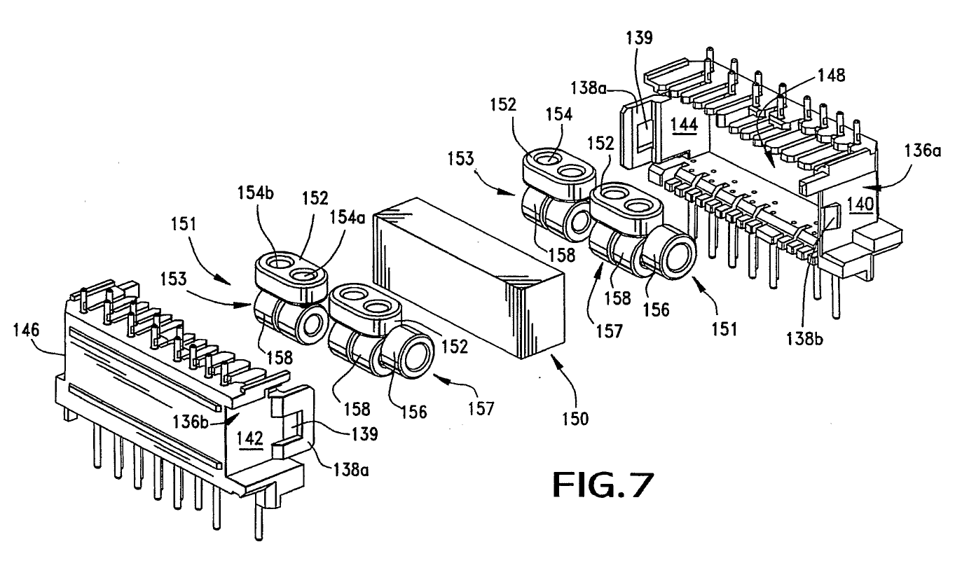

FIG. 7 illustrates the component housing 126 in a first aspect of the invention. As shown, the component housing 126 is a two piece assembly having a right housing 136a and left housing 136b for holding the magnetics 151, or filtering components. A shock absorbing insert 150 for cushioning the magnetics is provided as well. As can be seen, the left and right housings 136a, 136b are preferably physically identical for reducing manufacturing costs and increased ease of assembly. A latch 138a extends from the right sidewall 142, 144 of each housing. Preferably, each housing is formed from 30% GF LCP plastic resin or other similar material. The latch 138a includes an aperture 139 that engages a corresponding shoulder 138b located on the left sidewall 140, 146 of each housing. The shoulder 138b is configured as a ramp that gradually increases in height as it moves away from the opening 140 of the housing 136a and then ends abruptly downwardly. Each housing 136a, 136b, is formed with large opening 140, akin to a box without a lid. This opening enables the filtering magnetics 151, to be easily placed within each of the halves. Thus results in increased manufacturing efficiency.

The magnetics 151 provide impedance matching, signal shaping and conditioning, high voltage isolation and common-mode noise reduction. This is needed, for example, in 10/100 Base-T Ethernet that utilizes Unshielded Twisted Pair (UTP) transmission cable. The UTP wiring is prone to noise pickup, which may result in conducted and radiated noise emission. The magnetics help to filter out the noise, provide good signal integrity and electrical isolation.

The magnetics 151 include a transformer core 158, PoE choke core 156 and transformer choke core 152. For 10/100 Mbps communications, a common-mode choke is necessary for a system to pass FCC testing. The choke presents a high impedance to common-mode noise but a low impedance for differential-mode signals. Preferably both transmit and receive channels have a choke where both chokes are wired directly to the RJ-45 connector. Another consideration is crosstalk between transmit and receive channels. Crosstalk may create problems during EMC testing. Accordingly, magnetics with a shield between the two channels can minimize crosstalk. In addition, because of the additional DC current present in the PoE magjack, PoE systems require a resized common mode choke.

Because of the above requirements, the present invention provides a unique configuration of transformers and chokes to enable proper functioning of the magjack in all presently available communications systems. As shown in the exemplary embodiment, the magnetics 151 includes multiple core assemblies. The first is a standard or non-PoE core assembly 153 and the second is a PoE core assembly 157. Each housing, 136a, 136b receives and stores a standard core assembly 153 and a PoE core assembly 157.

Both types of core assemblies include a pair of transformer cores 158, such as those sold by Steward, part no. 46TOI45-00P. A transformer choke core 152, also sold by Steward, part no. 28N0277-11P is located on top of the transformer cores 158. It is to be noted that the transformer choke core used in this exemplary embodiment includes two holes 154a, 154b in what may be called a “double donut hole” configuration. By providing the two holes 154a, 154b, the core is able to support multiple transformer channels. Two channels are illustrated herein, but additional channels may be provided if needed.

Using the double donut hole configuration lowers the cost of materials since only a single part is required versus two separate chokes, as well as providing an elegant solution for multichannel use. It should be noted that functionally a pair of discrete single-hole choke cores could be used with equal effectiveness, but at a likely increased cost. In another exemplary embodiment (not shown), the PoE core may be split through the center so that an elongated aperture extends between the two holes 154a, 154b. A particular advantage of such a configuration would be to enable the possible automation of the winding process.

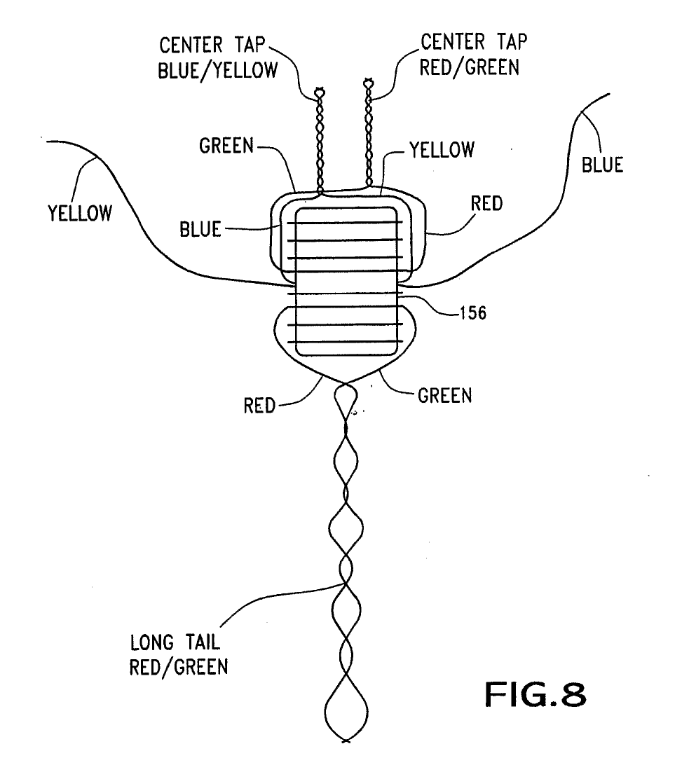

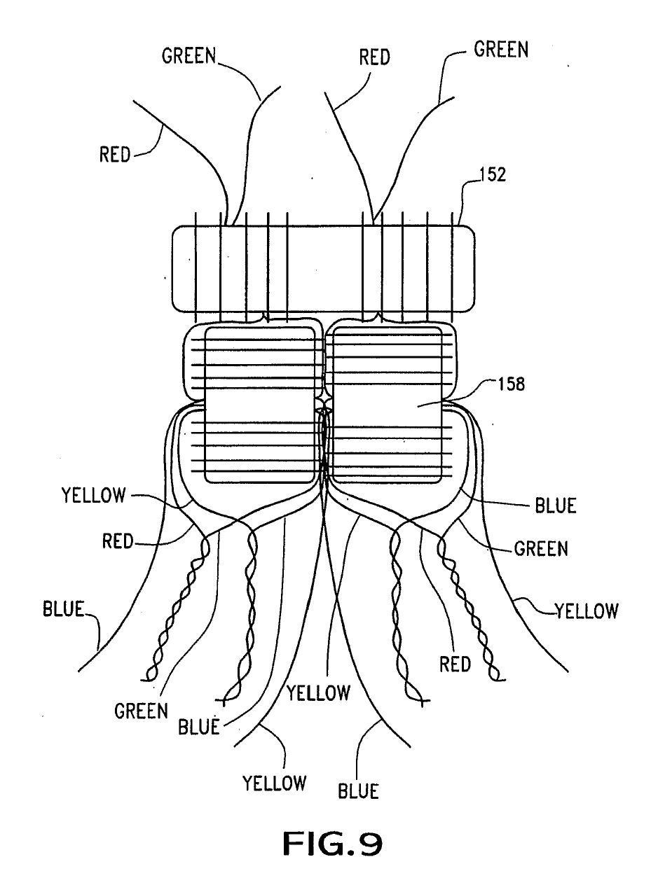

The PoE core assemblies 157 also include a PoE choke core 156 for providing the necessary size for the increased current of PoE systems. Such PoE transformer cores are also available from Steward, part no. 28T0155-00P. FIGS. 8-10, illustrate the wiring diagrams for the transformer wire winding assembly, the transformers and choke wire winding subassembly and the PoE choke wire winding assembly, respectively.

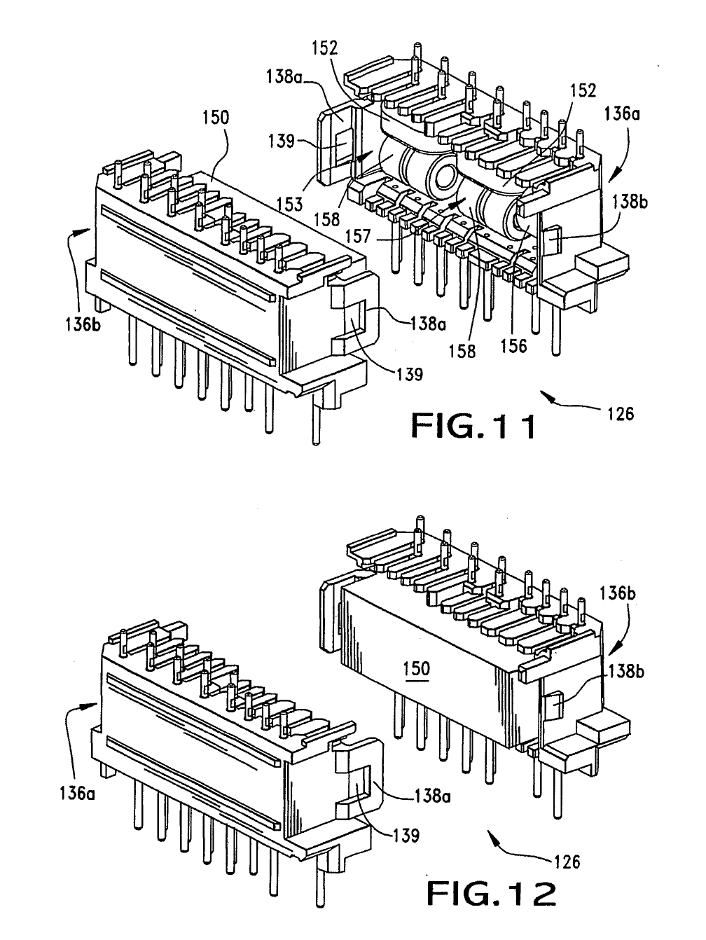

FIGS. 11 and 12 illustrate how the component housing 126 is assembled. First, the core assemblies of the magnetics 151 are wrapped in wire as shown in FIGS. 8-10. Then, each housing 136a, 136b receives two core assemblies, including the standard core assembly 153 and the PoE core assembly 157. The rubber shock-absorbing insert 150 is placed inside one of the housings 136a. The insert 150 is sized such that a portion of the insert 150 partially extends out from the opening of the housing (FIG. 12).

As the housings 136a, 136b are brought together, the latch 138a flexes slightly outwardly and moves up the ramp portion of the shoulder 138b. As the latch 138a crosses over the back edge of the ramp 138b, the latch aperture 139 fully engages the shoulder 138. The latch 139 is securely held in place by the flat end of the back portion of the shoulder 138b.

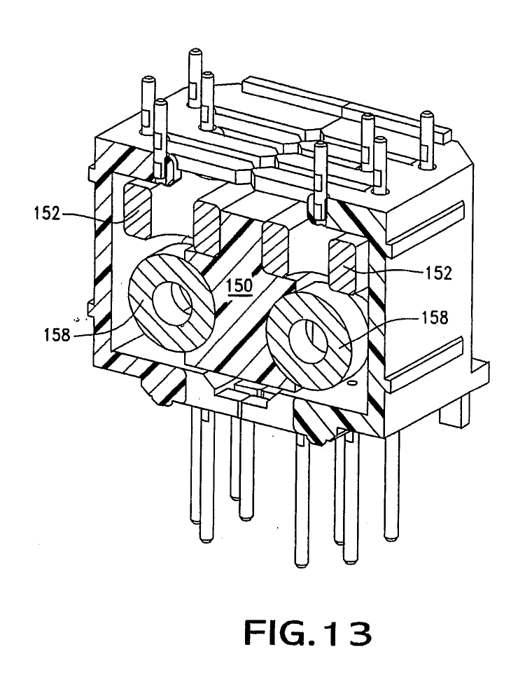

After assembly of the housings 136a, 136b, the shock absorbing insert 150 compresses against the magnetics 151. As shown in FIG. 13, the insert 150 deforms to the point of filling in spaces and crevices between the various transformers and chokes, such as the transformer core 158 and the transformer choke core 152. The insert 150 also presses these components against the sidewalls of the interior of their respective housings to prevent sudden or hard movement that could possibly break the components or cause the windings to break. Therefore, the insert 150, which may be made from cellular silicone rubber or other pliable material, provides soft cushioning for the components if needed.

Although the present invention has been described in terms of the presently preferred embodiments, it is to be understood that the disclosure is not to be interpreted as limiting. Various alterations and modifications will no doubt become apparent to those skilled in the art after having read the above disclosure. Accordingly, it is intended that the appended claims be interpreted as covering all alterations and modifications as fall within the true spirit and scope of the invention.

What is claimed is:

1. A modular jack, comprising:
a housing having first and second portions, wherein the first and second portions are configured to engage each other to form a box-like enclosure having a cavity therein for containing one or more components and further including an opening for receiving a mateable connector;
a plurality of contacts mounted within the housing for engaging contacts of the mateable connector when the mateable connector is inserted into the modular jack housing;
a filtering assembly comprising one or more filtering components located within the cavity of the modular jack housing for filtering signals present on at least one of the plurality of contacts; and
an insert located between the first and second housing portions for protecting the filtering assembly from mechanical forces.

2. (canceled)

3. The modular jack of claim 1, wherein the insert is formed of a resilient material compressively held against the filtering assembly when the first and second portions are engaged.

4. The modular jack of claim 1, further comprising a compound for fixing the filtering assembly in place within the modular jack housing.

5. The modular jack of claim 3, wherein the resilient material is rubber.

6. The modular jack of claim 5, wherein the rubber is comprised of cellular silicone rubber.

7. The modular jack of claim 4, wherein the fixing compound comprises a potting material.

8. (canceled)

9. The modular jack of claim 1, wherein the filtering components include at least one transformer choke core.

10. The modular jack of claim 9, wherein the transformer choke core includes two holes.

11. (canceled)

12. A method for assembling a modular jack, comprising:
providing a housing having first and second portions, wherein the first and second portions are configured to engage each other to form a box-like enclosure having a cavity therein for containing one or more components and further including an opening for receiving a mateable connector;
mounting a plurality of contacts within the housing for engaging contacts of the mateable connector when the mateable connector is inserted into the modular jack housing;
placing a filtering assembly comprising one or more filtering components within the cavity of the modular jack housing for filtering signals present on at least one of the plurality of contacts; and
placing a compressible insert within the cavity to engage the filtering components.

13. (canceled)

14. The method of claim 12 further comprising the step of utilizing at least one transformer choke core as one of the filtering components.

15. The method of claim 14 further comprising the step of forming the transformer choke core with two holes.

16. (canceled)

17. A component housing, comprising:
a first housing portion and a complimentary interlocking second housing portion, said first housing portion including a cavity and said first and second housing portions forming a hollow chamber when the housing pieces are interlocked;
a core assembly comprising a transformer core and a transformer choke core for filtering signals, the core assembly received within the cavity of the first housing portion; and
a compressible insert located within the hollow chamber when the housing pieces are interlocked to engage components of the core assembly.

18. The component housing of claim 17, wherein the compressible insert is formed from a rubber compound.

19. The component housing of claim 17, wherein the transformer choke core is configured with multiple holes.

20. (canceled)
